(19) United States
(12) Patent Application Publication
(10) Pub. No.: US 2012/0192505 A1
(43) Pub. Date: Aug. 2, 2012

(54) Wood construction members and methods

(76) Inventor: Alfred Lawrence Michaelsen, Loudon, TN (US)

(21) Appl. No.: 12/931,379

(22) Filed: Jan. 31, 2011

(51) Int. Cl. E04B 2/70; B27M 1/08; E04C 2/52; H02G 1/06; E04C 2/38; E04B 1/19

(52) U.S. Cl. 52/105; 52/578; 52/653.1; 52/220.1; 254/134.3 R; 144/360

(57) ABSTRACT

Disclosed is a “2 by” (or “2×”) wood construction member, e.g. a 2×4 or a 2×6, having conventional width and thickness but which has a longitudinal cross sectional area which is less than the longitudinal cross sectional area of a regular corresponding 2 by. The reduction in cross section area is achieved by removing material from a longitudinal major surface, e.g. a side or edge surface. When such a member is used in the wall of stick house, a wiring channel is thereby provided. Also disclosed are methods of making such a member.

### BACKGROUND OF THE INVENTION

This invention relates to the building construction field and specifically to the construction of buildings, for example homes, wherein the walls are constructed of wood members.

Most homes and many other structures, for example garages and other buildings, are constructed from standard sized lumber or wood members. The members which are vertically oriented in the wall are referred to as “studs” and generally have nominal cross sectional dimensions of 2×4 or 2×6 inches. As used herein, a “stud” means a wood member for use in or incorporated in a wall and oriented vertically. The most typical length for a stud is 93.625 inches, although longer lengths may be employed if the ceiling height is greater than 8 feet. Generally, studs are provided in 2-foot increments, e.g. 8, 10 feet, 12 feet, etc.

As is understood in the building trades, “nominal” means that a member having nominal dimensions of 2 inches×4 inches has actual dimensions of approximately 1.5 inches×3.5 inches. Similarly, a member having nominal dimensions of 2 inches×4 inches, has actual dimensions of 1.5 inches by 3.5 inches. In other words, the actual cross sectional dimension of such building lumber is about one half inch less than each of the stated numbers. Hereinafter, when dimensions are provided, such dimensions are nominal dimensions, unless otherwise noted.

2 by's have 6 surfaces, i.e. two major surfaces, two minor surfaces and two end surfaces. The surfaces which comprise each pair are parallel and spaced apart from each other. A major surface has the widest width. For example, in a 2×4 the surface having a nominal width of 4″ would be a major surface and a minor surface would have a thickness of nominally 2″. The two major surfaces and the two minor surfaces are herein referred to as the longitudinal surfaces. The end surfaces are at each end of the member. The longitudinal cross sectional area of such a member is the area seen when looking perpendicular to an end surface. The cross sectional area of 2×4's and 2×6's are respectively 5.25 and 8.25 square inches.

As is well known, in a wood frame wall the studs are the vertical members. Extending transverse to the studs, at the top and bottom thereof, are so-called plates. As used herein, a “plate” is a 2× having a length of 10 feet or longer. Each plate is wood. The “plate” at the bottom is called the bottom plate. The plate at the top is called the top plate. The plates generally have the same cross-sectional dimension as the studs. The studs are typically spaced 16 inches on center. A building, e.g. a residential house, constructed in this manner is often referred to as a “stick” house.

Under current practice, when a stick house is being built and the framing is complete and the exterior sheathing is in place, electrical wiring is typically then installed. In doing so, the first step is to identify the location of all power outlets or signal outlets (e.g. TV cable outlet or phone line boxes). Similarly, the location of switches is identified. Appropriate boxes, herein generically called junction boxes, for outlets or switches are then mounted at the identified locations. Then, a cable is “run” from each outlet box to a distant location in the house and from each switch box to an outlet box. For example, if the cable is to carry electrical power (a “power supply cable” or “psc”), a cable is connected from each outlet box, with perhaps an intermediate connection to a switch, to the circuit breaker box. Typically, a number of outlet boxes are connected in series, i.e. a number of outlet boxes are serviced by a single psc. The maximum number of outlet boxes on a single psc may be determined by the local building code. However, it is not at all unusual for there to be 5 or 6 outlets connected in series on a single psc, i.e. connected to a single breaker. Similarly, signal carrying wire, e.g. coax wire, will be run from each signal outlet to the point in the house where the external coax wire enters the house. Usually, coax wire or line is brought into a house at about the same location as the circuit breaker box.

FIG. 1 shows a front sectional view of a completed exterior wall of a house which I recently helped construct, i.e. the wall is shown without any interior covering such as wallboard. The exterior of the wall is wood sheathing 14, which is affixed to the outer surfaces of the studs. The wall is comprised of a bottom plate 15, vertically extending studs 12, a top plate 20 and a cap plate 17. The studs are nailed to the respective plates. The bottom plate 15 rests on the sub-floor 16, which rests on the sill plate 13 which rests on the concrete foundation 11. In the section shown, there are 3 studs 12, each being a “2 by”, i.e. having a nominal cross section of either 2×4 or 2×6.

Also shown are two outlet boxes 5 and 7 which are affixed to respective studs 12. A psc 18 passes through a drilled hole (not shown) in the top plate 17 and the cap plate 20 and then descends down to the outlet box 5. To provide power to the next outlet box 23, a psc 9 is run upwardly from outlet box 5, through the drilled holes in the top plate and the cap plate and then along the cap plate and then down, through another drilled hole (not shown) to outlet box 7. The house which I helped construct was relatively small, i.e. a single story house having an area of about 1200 square feet. Yet, there were 6 power lines which serviced 25 outlet boxes. In a two-story house, the number of power cables and outlet switch boxes will often be double this number and in a custom built house triple this number.

In the house I helped construct, a common practice was used to run the psc's and signal cables. Specifically, as described above, a line, e.g. 18, was run down to an outlet box and then back up and across the cap plate and down to the next outlet box and then repeatedly up and down to other boxes. The height of the walls in this house was 8 feet. The outlet boxes were mounted about 12 inches above the floor. Thus, although the boxes 5 and 7 were only 32 inches apart, about 17 feet of wire was used to connect boxes 5 and 7, i.e. about 7 feet up from box 5, 3 feet across and 7 feet down to box 7. There were 3 other outlet boxes on this line. FIG. 2 shows schematically the wiring path for all these boxes, i.e. 1, 2, 3, 4 and 5. As can be seen in FIG. 2, about 56 feet of wire was used to effect the up and down runs of the psc. The psc used was typical for such construction, i.e. it was comprised of two insulated 14 gage conductors and a 14 gage ground wire, all which was surrounded by plastic sheath. Such cables typically have a thickness or minimum dimension of about 0.3 inches and a width of about 0.4 inches and thus typically have a cross sectional area of about 0.12 square inches.

In recent years the price of copper has increased significantly. As a result, power cable of the type just described typically costs about $0.55/foot. One compelling indication of the aggregate value of copper wire installed in a new house is the fact that it is now sadly not unusual, when a house is under construction and “rough” wiring has just been installed, for thieves, on the night when wiring has just been completed, to steal all the wire.

An alternative approach to “ ” running psc's is for an electrician or other trade person to drill a hole through each stud between outlet boxes to be connected. Drilling such holes is a time consuming task. For example, if the structure is to be a two-story residence having 3,000 square feet of living space and a basement, the first and second stories each might have a cross section of 30 by 50 feet, or a total perimeter of 160 feet, which would contain, with standard 16 inch spacing between studs, 120 studs per floor. If only half the studs had to be drilled for wiring, 120 studs would have to be drilled, i.e. 60 per floor. Because of the labor involved, many electricians disfavor this approach. Additionally, care must be exercised when drilling such holes to ensure that the periphery of the holes is not so close to the side face of the stud that a nail or screw, used to fasten the interior wall covering to the wall, does not enter the space. If that were to happen, the nail or screw could enter the psc and cause a short circuit. This matter is of significant concern because most building codes proscribe limits on the spacing between the side edge of the stud and the periphery of the hole. Failure to comply with these limitations would result in a code enforcement inspector refusing to approve the construction. The same result would also occur if care was not exercised in determining the size of the hole because each hole reduces the strength of the stud. Most building codes address this issue and proscribe the maximum diameter allowable.

The practice of the invention disclosed herein eliminates or substantially reduces the need to drill such holes while also reducing substantially the quantity of wire used when such holes are not employed. Thus, construction costs and time are reduced at virtually no additional cost.

### SUMMARY OF THE INVENTION

Each wall in a stick house includes at least one 2× plate, preferably the bottom plate, and each such plate has a longitudinal cross sectional area which is less than the longitudinal cross sectional area of a standard or regular member, e.g. the stud which rests upon it. The longitudinal cross sectional area of a member embodying the invention has had its area reduced by the removal of a material from a major surface. Desirably, this is achieved by forming a groove extending longitudinally along at least the length of the plate which is in contact with or to be in contact with studs through which a wire must pass. In the wall, the side of the plate including the groove is positioned to face and abut each stud. Thereby, a closed wiring channel is provided and defined by the groove formed in the plate and the end surface of the stud.

Removing the material is done in such a way as to ensure that the resulting member, when used, does not experience stresses greater than those proscribed by the International Residential Code.

Another embodiment of the invention resides in a method for constructing a wall which is comprised of a plurality studs and plates, wherein the method includes the steps of providing a plurality of studs, providing a plurality of plate forming members, at least one of which includes a groove formed in at least one of its longitudinal surfaces and extending longitudinally, and fastening each stud, at opposite ends, to the respective plate members. Thereby, a closed wiring channel is provided where each end of each stud abuts the plate containing the groove. This method may further include the step of passing an electrical wire through at least some of the enclosed wiring channels.

Another embodiment of the invention resides in providing a method for producing plates of the described above. In this embodiment, the groove is formed during the process of making the plate, thereafter the plates are stacked, banded together in quantities greater than 20 and are shipped to the construction site and then incorporated in a wall.

### DESCRIPTION OF THE DRAWINGS

FIG. 1 is a view in elevation of a section of the inside of an exterior wall of a house under construction.

FIG. 2 is schematic view of a prior art “wiring run”.

FIG. 3 is a sectional view of a plate embodying a specie of the invention.

FIG. 4 is an end view of a plate showing another embodiment.

FIG. 5 is an end view of a plate showing another embodiment.

FIG. 6 is a sectional view of a bottom portion of a wall containing a plate embodying the invention.

FIG. 7 is a side view of a member spanning a distance and carrying a load.

FIG. 8 is a perspective view of a corner where two walls meet.

FIG. 9 is a side view of a sectioned plate.

FIG. 10 is a top view of the structure shown in FIG. 8.

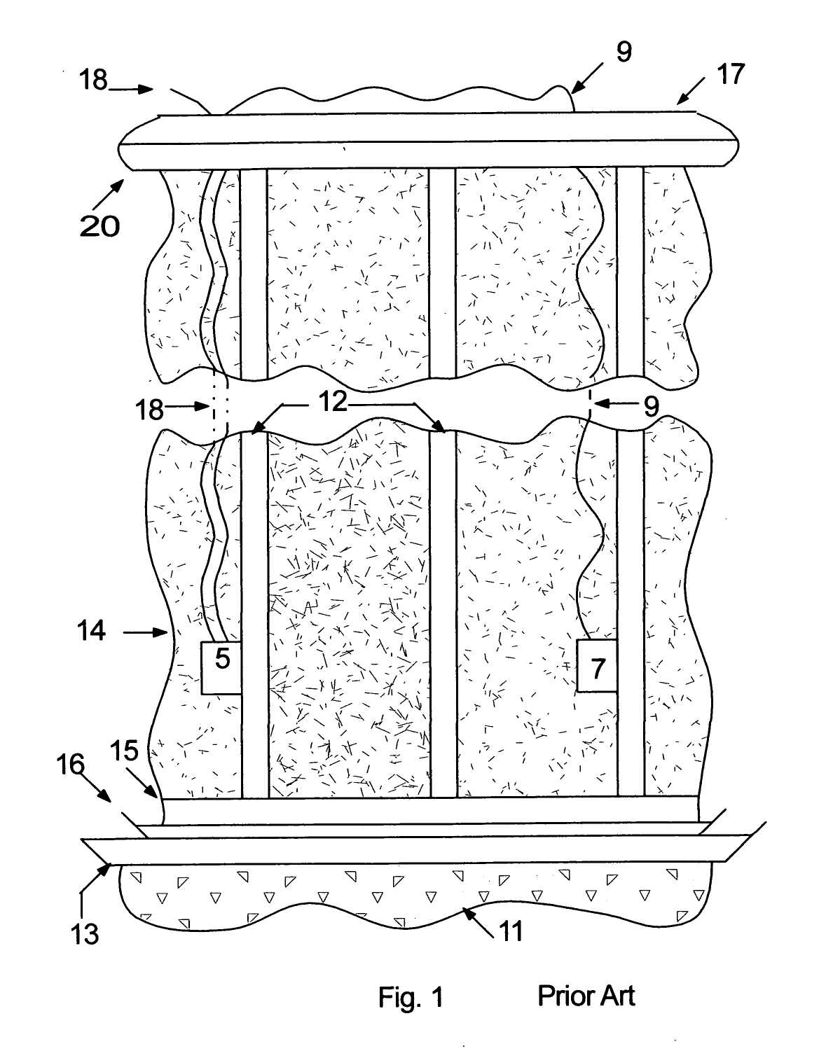

### DESCRIPTION OF THE INVENTION

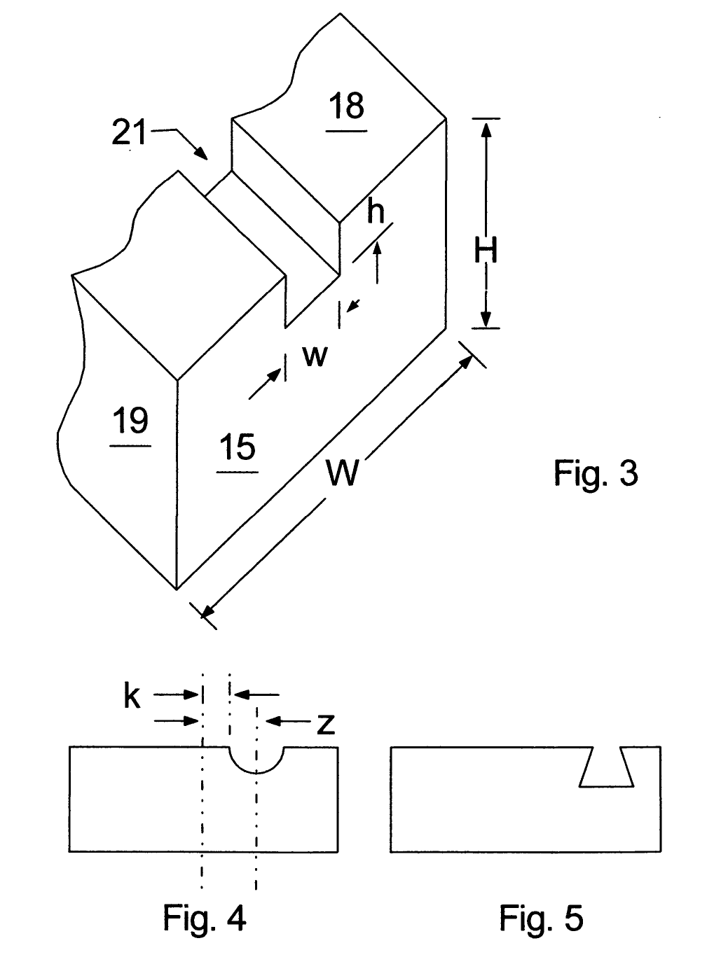

FIG. 3 shows, not to scale, an end portion of a plate 15, e.g. a bottom plate, which may be a 2×4 or a 2×6. The plate has a top major surface 18 and a side or minor surface 19. Formed in the top major surface 18 is a longitudinally extending groove 21. The plate and the groove have the indicated generalized dimensions. FIGS. 4 and 5 show end views of a plate having respective grooves. These figures indicate that the groove 21 need not be rectangular in cross section as shown in FIG. 3 but may be of a variety of cross sections, e.g. arcuate as shown in FIG. 4 or the shape shown in FIG. 5. Any one of the aforementioned cross sectional geometries may be formed by a router or, in the case of the rectangular geometry of FIG. 3, formed with a dado blade or ganged saw blades. Grooves having other cross section geometries may be used. The groove is to be provided in a longitudinal surface. Providing a groove reduces the longitudinal cross sectional area of the member, i.e. the area seen when looking at an end surface of the member, but increases the surface area of the member. As shown in FIG. 3, the groove has a height h and a width w. As shown, the height h is less than the height H of the plate 15 and the width w of the groove 21 is less than the width W of the plate. Since the plate 15 is a 2×, H is equal to 1.5 inches. Thus, h is less than 1.5 inches.

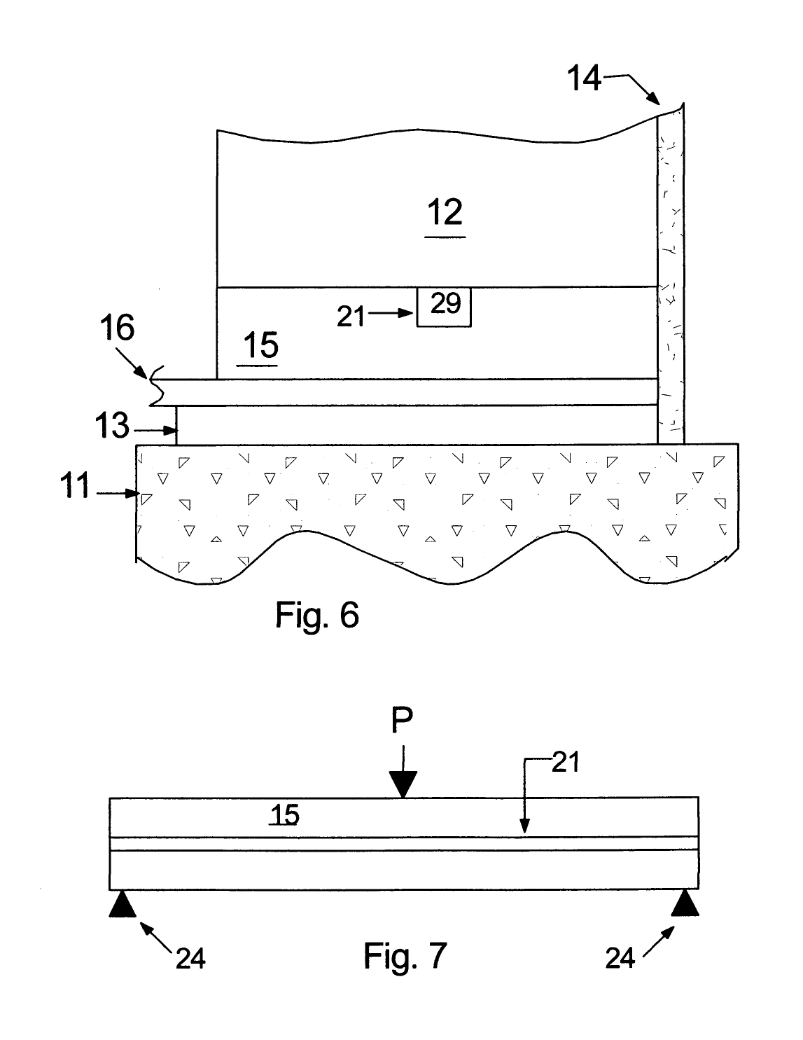

FIG. 6 shows a section of the bottom portion of a wall resulting from incorporating the plate 15 in the wall construction of a stick house and in particular an external wall. Specifically, FIG. 6 shows a major surface of a stud 12 and the bottom plate 15. As can be seen in FIG. 6, the stud 12 does not have a slot formed in its major face. Exterior sheathing is shown at 14. The bottom plate 15 rests on the sub-floor 16 which, in turn, rests on the sill plate 13 which sits on top of the foundation 11. As will be seen, the groove 21, in combination with the end surface of the stud 12, forms a wiring channel 29 through which a power supply cable (not shown) may be passed. Although in FIG. 3 the groove is located in the center of the top surface of the bottom plate, that placement is not required although generally preferred for 2×4's. For 2×6's, the preferred location is spaced from the centerline of the plate.

Thus it will be appreciated that by virtue of forming the groove 21 in the bottom plate 15, without any labor on the part of the carpenters or the electricians building the house, power supply cables may be run from one junction box to another without drilling any holes and with an attendant substantial saving in the quantity of cable consumed.

When a plate embodying my invention is fastened to the studs, it is possible that a nail may be placed in a location which results in the nail entering the groove. To avoid that problem, it is desirable to provide on the opposite surface indicia indicating where a nail should not be placed. Such indicia may be a wide black line, a series of X's or any other kind of indicia.

When practicing this embodiment of my invention in any of its many forms, it may be desirable to exercise care when locating the groove and determining its area and shape. Specifically, it may be desirable to locate the groove so that it is reasonably close to or aligned with the longitudinal centerline of the plate. Care in this regard is prudent if the member comprising the plate could be used in another application, viz. in an application wherein the member is used to span a distance and carry a load applied parallel to its major surfaces. One example of such an application is when such a member is used as a header. Other such applications are foreseeable because plates are usually made and provided in lengths of 12 to 16 feet and thus might be used to span long distances.

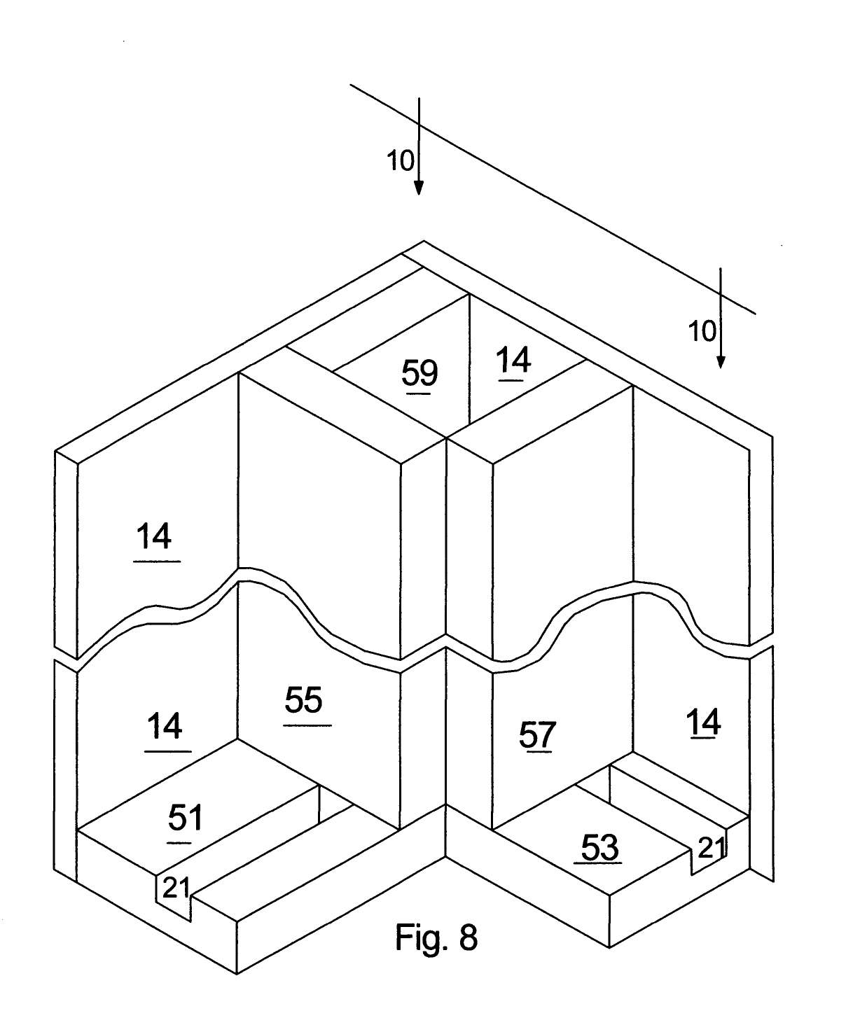

FIG. 7 shows in side view and somewhat diagrammatically such an application. The member 15 with the groove 21 is supported at points 24. A load P is exerted on the member 15 as shown. Although the load P is shown as a single load at the center, it will be appreciated that the load may also be a distributed load along the top surface of the 15 or a combination of a single load and a distributed load. In any event, top loading will cause the member 15 to deform and consequently the upper half of the member 15 would be in compression and the lower half in tension. The longitudinal centerline of the member, sometimes referred to as the “neutral axis”, would not be subjected to either compression or tension. So, to the extent that the groove is as close as possible to the longitudinal center line, the reduction in bending strength is reduced. The forgoing considerations may be satisfied if it is ensured that the dimensions indicated satisfy the following relations—

20≧[Aₘ(W²)]/[Aₘ(W²)/12+Aₘ(W/2−x)²]−[a_{g}(w²)/12+a_{g}(W/2+z−x)²]

wherein

x=[(Aₘ)(H/2)−a_{g}(H/2+z)]/(Aₘ−a_{g})

wherein h, w, H, and W are the actual dimensions in inches for respective quantities shown in FIG. 3, Aₘ is the cross sectional area of the member without the groove, a_{g} is the cross sectional area of the groove, and z is the distance from the center line of the member to the center line of the groove. In addition to the foregoing, the following relations are desirably satisfied

h≧0.4 and w≧0.3 or h≧0.3 and w≧0.4; and a_{g}≧0.2 and 1.5(W−w)≧2.25

The location and dimensioning of the groove must also be considered with respect to the impact it may have on shear stresses induced in the member if it is to be subjected to bending as shown in FIG. 7. To address this concern, the following relation is desirably satisfied—

1≧[1−k/(W/2)](H)/(H−h)

wherein W, H and h are the actual dimensions in inches for the respective dimensions shown in FIG. 3 and k is the distance, in inches, from the longitudinal centerline of the member to the edge of the groove nearest the centerline. Preferably a_{g} is ≧0.5 sq. in. and more preferably a_{g≧}0.75 sq. in. In a 2×4, desirably w is >h.

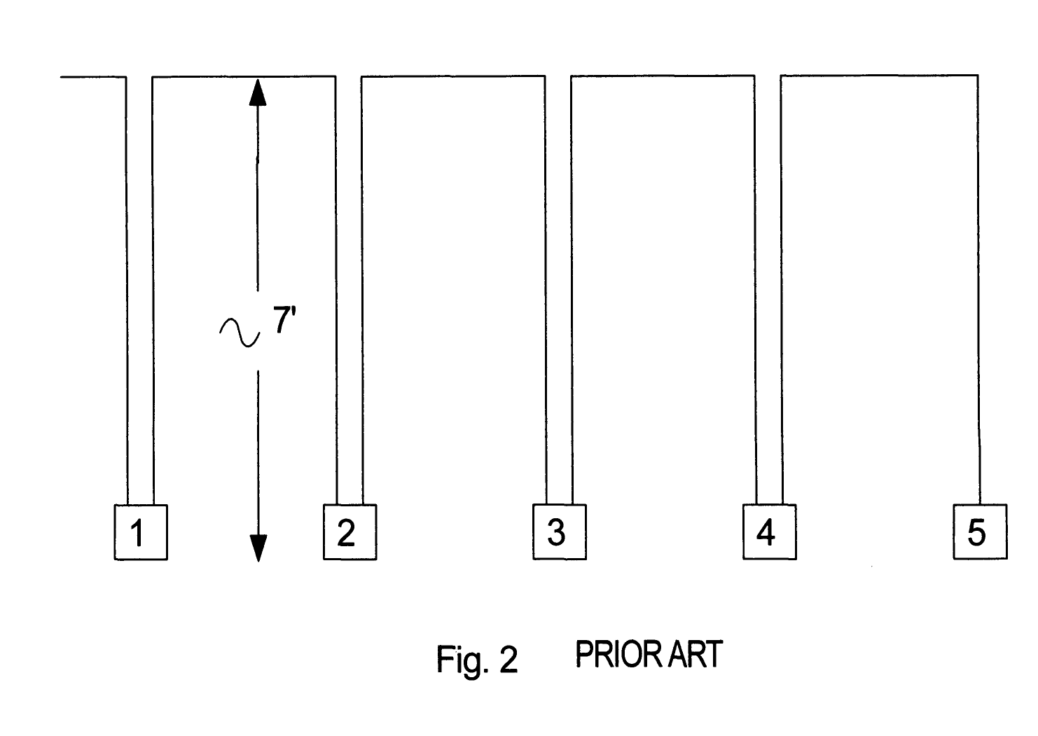

As can be appreciated by considering the construction shown in FIG. 3, the use of my invention results in a dramatic reduction in the quantity of wire required to connect commonly supplied junction boxes or the labor required to accomplish that result. Specifically, rather than, as shown in FIG. 2, running the power supply cable up from a box and then down to next box, the cable may simply be inserted through the wiring channel provided, thereby saving about 14 feet of cable for each of box or saving the time required to drill numerous holes must be located and sized with care.

FIG. 8 shows still another embodiment of my invention. This isometric view shows a corner construction of a stick house, i.e. the corner formed by two walls. In this view, the top plate and cap plate have been omitted for clarity. Shown is a bottom plate 53 with two studs 57 and 59 mounted thereon. The studs are conventional, i.e. they do not have slots extending through them from one major surface to the other and which extend substantially along the stud, from each end to a center portion substantially intermediate the ends of the stud. Stated differently but equivalently, the cross sectional area of the studs is substantially constant along the length of the stud. The stud 59 is the end of the wall at which bottom plate 53 is located. Stud 57 is spaced from stud 59 so that the distance between the two opposing faces is equal to the width of a stud. Abutting plate 53 is the bottom plate 51 of the intersecting wall. The last stud on this end of the plate 51 is stud 55. When constructed, a major face of stud 55 abuts and is nailed to an end face of the stud 59. The edges of studs 55 and 57 substantially intersect so that their end faces provide surfaces for mounting interior covering, e.g. wallboard. Each of the bottom plates 51 and 53 includes a groove 21.

FIG. 8 illustrates another benefit of my invention. Specifically, because of the presence of the grooves 21, a psc can “turn the corner” without the need to run it up through the top plates and back down through the top plates in order to go from one wall to the other, thereby saving about 15 feet of cable and avoiding the need to drill two holes through each of the two top plates. In this regard, running a psc “around the corner” can be facilitated by providing a conduit positioned in the grooves. The conduit may be of short length, e.g. about the length required to turn the corner, although longer lengths may be used. This approach may be effected as follows. Assume that the bottom plate 53 and its associated wall comprise the front wall of the house. That wall is erected first and fastened to, for example, the sub-floor and the underlying sill plate. A conduit is then placed in the groove 21 and passes under the stud 57 and is deformed so that it turns 90 degrees toward where the next wall will be located. The wall, which has at its base bottom plate 51, is then moved into place and, in the process thereof, the distal end of the conduit is paced in the groove of plate 51. That wall is then secured to the underlayment and stud 55 is fastened to stud 59.

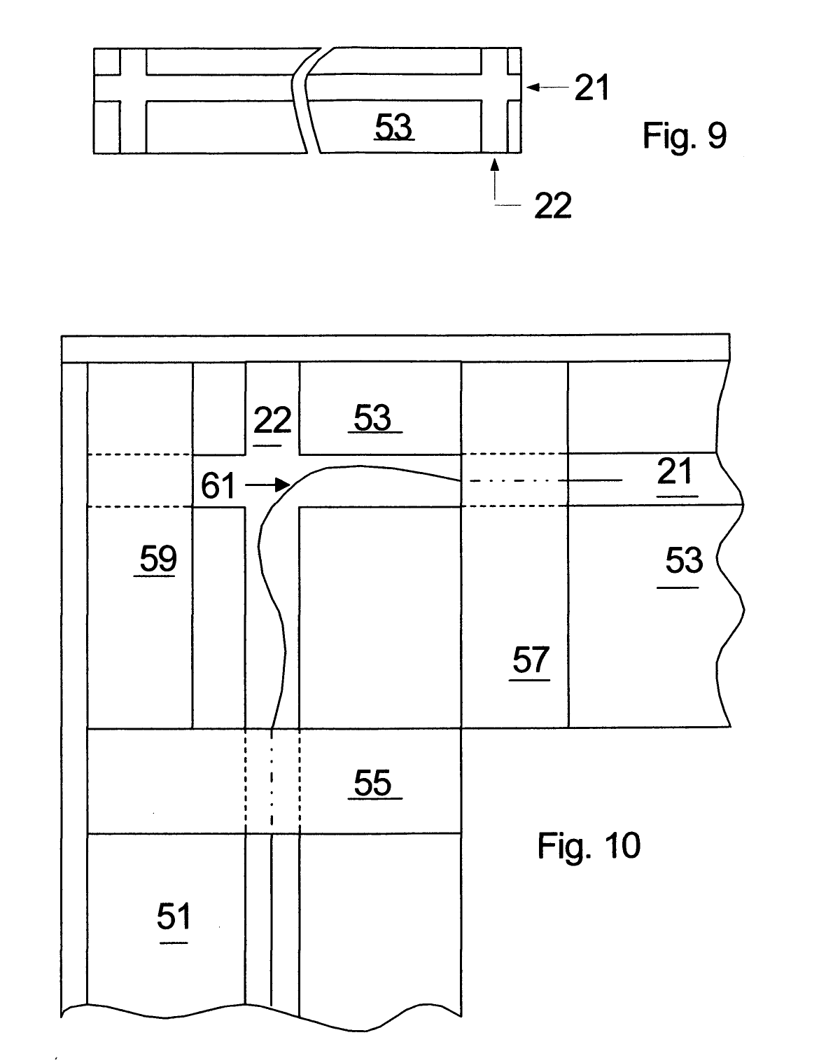

FIG. 9 is a side view of a plate 53 and shows another embodiment of the invention. As can be seen in FIG. 9, the plate 53 does not have a slot formed therein which extends from one major surface to the other and which extends longitudinally substantially a ong the entire length of the plate. A groove 21, as described above, has been formed in the plate 53 and extends longitudinally along the length of the plate and its centerline is somewhat offset from the centerline of the plate 53. Additionally, formed at each end of the plate is another groove 22, which is spaced from respective ends of the plate and interests the groove 21. The benefit of providing these transverse grooves is illustrated in FIG. 10, which is a top view of the structure shown in FIG. 8. As shown in FIG. 10, a portion of a psc 61 lies in the groove 21 and then turns and extends the groove 21 in the plate 55.

As a consequence of that construction, a power supply cable may be inserted into the conduit and pushed through so that it thereby easily turns the corner.

The conduit can be made of any suitable material, e.g. metal or a polymer. However, to function it must have an internal diameter (i.d.) greater than or equal to at least about 0.5 inches and the dimensions of the groove must be such that the conduit will pass through. At least two different expedients can be uses to assist in running the cable through the conduit, i.e. either (1) the interior of the conduit or the exterior of the cable or both can be provided with a “non-slip” coating, i.e. silicone of PTFE; or, before the conduit is initially inserted a wire or string can be threaded therethrough and left with ends extending outward and one of those ends can be attached to the cable and the cable then pulled through the conduit.

The constructions described above demonstrate that through the use of my invention, a house may be constructed having two abutting and orthogonally disposed walls, each having a plurality of outlets and switches, and all of the boxes and switches may be wired by a single line which passes only once through a plate. The consequent savings in labor and material is substantial.

Another attribute of my invention is the ease and low cost with which plates embodying the invention may be fabricated and the benefits which derive when the groove is provided when the plate is created. Specifically, “2 bys” are formed at a lumber mill. In operation, after a log is debarked, it is repeatedly passed through a band saw to produce a rough cut lumber slab slightly thicker than that of the ultimate, desired lumber, e.g. an actual thickness of about 2 inches for a final 2× piece. The resulting product is then “edged” to create four-sided lumber. The “edged” piece is then trimmed to create a piece of the desired length. After sorting and drying, the piece is passed through a planer which provides smooth surfaces and which is uniform in width and thickness. As the piece exits the planer, by using either a router or a circular saw with a dado head, the groove may formed in one of the finished surfaces. The router or saw forms the groove as the piece passes under it and is movable in a direction transverse to the path of the piece is that it may be repositioned, for example under computer control, depending on the desired location of the groove and the width of the piece.

While different embodiments of my invention have been disclosed, others may be derived by those skilled in the art without nevertheless being with the scope of the appended claims.

1-30. (canceled)

31. A stick house having a wall comprising:
a) two spaced apart generally horizontally disposed 2× wood plates, each having a width W;
b) a multiplicity of spaced apart 2× wood studs vertically disposed between said plates and having a width W equal to the width of said plates, each of said studs having two end faces which abut respective major surfaces of said plates, each of said studs being attached at respective ends to said respective plates, each of said studs not having two slots (i) which each extend through said stud from one major surface to the other and (ii) which each extend vertically from respective ends of said stud to a point substantially intermediate the ends of said stud, and a wiring channel located between at least one end of at least one stud and the plate to which it is attached.

32. A stick house having a wall comprising:
c) two spaced apart generally horizontally disposed 2× wood plates, each having a width W;
d) a multiplicity of spaced apart 2× wood studs vertically disposed between said plates and having a width W equal to the width of said plates, each of said studs having two end faces which abut respective major surfaces of said plates, each of said studs being attached at respective ends to said respective plates, each of said studs having a constant cross sectional area along substantially its entire and a wiring channel located between at least one end of at least one stud and the plate to which it is attached.

33. The wall of claim 32 wherein the plate adjacent said wiring channel has a groove formed in a major surface thereof which abuts said stud, the groove having a height h and a width w and a cross sectional area a_{g}, wherein: 1.5>h≧0.4 and w≧0.3 or 1.5>h≧0.3 and w≧0.4; 1.5(W−w)≧2.25 and a_{g}≧0.2, and wherein h and w are in inches and a_{g} is in square inches.

34. The wall of claim 33 wherein with respect to said plate the following relations are satisfied:
20≧[Aₘ(W²)]/[Aₘ(W²)/12+Aₘ(W/2−x)²]−[a_{g}(w²)/12+a_{g}(W/2+z−x)²]
wherein
x=[(Aₘ)(H/2)−a_{g}(H/2+z)]/(Aₘ−a_{g})
wherein h, w, H, and W are the actual dimensions in inches for the respective quantities, Aₘ is the cross sectional area of the member without the groove, a_{g} is the cross sectional area of the groove, and z is the distance from the center line of said member to the center line of said groove.

35. The wall of claim 33 wherein said plate having a groove formed in a major surface further includes indicia on the opposite major surface which extends longitudinally along said opposite major surface and is transversely aligned with said groove.

36. The wall of claim 33 wherein said plate further includes at least one transverse groove formed in the said major surface and which intersects said longitudinal groove.

37. The wall of claim 33 wherein said plate has a height H, and wherein the following relation is satisfied: 1≧[1−k/(W/2)](H)/(H−h) wherein W, H and h are the actual dimensions in inches of said plate and the groove and k is the distance, in inches, from the longitudinal centerline of the member to the edge of the groove nearest the centerline.

38. The wall of claim 33 wherein said groove is either rectangular or arcuate in cross section.

39. The wall of claim 33 wherein the centerline of said groove is substantially aligned with the centerline of said plate.

40. A wall of a stick house comprising:
a) top and bottom plates and a cap plate;
b) studs extending vertically and fastened at respective ends to the bottom plate and top plate, the studs being spaced apart from each other and each having a constant cross sectional area along the entire thereof;
c) at least two junction boxes; and
d) a cable containing electrical conductors extending from one junction box to the other which passes between an end of each intervening stud and the plate associated therewith.

41. A 2× wood member having a length of at least 10 feet and a width W inches and having a groove formed in a major surface thereof which extends longitudinally along substantially the entire length of said member, said groove having a height h, a width w and a cross sectional area a_{g}, wherein h, w and a_{g} satisfy the following relations: 1.5>h≧0.4 and w≧0.3 or 1.5>h≧and w≧0.4 and a_{g}≧0.2 and 1.5(W−w)≧2.25, wherein h and w have units of inches and a_{g} has units of square inches.

42. The wood member of claim 41 wherein the following relations are satisfied:
20≧[Aₘ(W²)]/[Aₘ(W²)/12+Aₘ(W/2−x)²]−[a_{g}(w²)/12+a_{g}(W/2+z−x)²]
wherein
x=[(Aₘ)(H/2)−a_{g}(H/2+z)]/(Aₘ−a_{g})
wherein h, w, H, and W are the actual dimensions in inches for the respective quantities, Aₘ is the cross sectional area of the member without the groove, a_{g} is the cross sectional area of the groove, and z is the distance from the center line of said member to the center line of said groove.

43. The wood member of claim 41 wherein said member has a height H, and wherein the following relation is satisfied: 1≧[1−k/(W/2)](H)/(H−h) wherein W, H and h are the actual dimensions in inches of said plate and the groove and k is the distance, in inches, from the longitudinal centerline of the member to the edge of the groove nearest the centerline.

44. An improvement in the method of making a 2× member having a width W which comprises the steps of:
a) debarking a log;
b) rough cutting a slab from said debarked log;
c) trimming said slab, and
d) planning said trimmed slab, wherein the improvement comprises
forming a groove in a major surface of said member, said groove having a height h and a width w and a cross sectional area a_{g}, wherein: 1.5>h≧0.4 and w≧0.3 or 1.5>h≧0.3 and w≧0.4; and a_{g}≧0.2, 1.5(W−w)≧2.25 and wherein h and w are in inches and a_{g} is in square inches.

45. The improved method of claim 44 where said groove has a rectangular cross section.

46. The improved method of claim 44 where said groove has an arcuate cross section.

47. The method of wiring a partially constructed stick wall having at least two junction boxes mounted on different studs, each of said studs having a constant cross sectional area along substantially its entire length, comprising the steps of:
a) passing one end of an electrically conducting cable between one end of each intervening studs and plate associated therewith; and
b) passing the respective ends said cable through and into respective ones of said junction boxes.

48. The method of claim 47 wherein said cable is passed between respective ones of said studs and the associated bottom plate.

46. The method of claim 47 wherein said cable is passed between respective ones of said studs and the associated top plate.

47. The method of claim 47 wherein said cable is a power supply cable.
